(19) United States
(12) Patent Application Publication
(10) Pub. No.: US 2019/0324313 A1
(43) Pub. Date: Oct. 24, 2019

(54) FLUID CELL, THREE-DIMENSIONAL FLUID CELL, AND METHOD FOR MANUFACTURING THREE-DIMENSIONAL FLUID CELL

(71) Applicant: FUJIFILM Corporation, Tokyo (JP)

(72) Inventors: Yuzo FUJIKI, Minami-ashigara-shi (JP); Hajime NAKAYAMA, Minami-ashigara-shi (JP); Rikio INOUE, Minami-ashigara-shi (JP)

(73) Assignee: FUJIFILM Corporation, Tokyo (JP)

(21) Appl. No.: 16/460,689

(22) Filed: Jul. 2, 2019

Related U.S. Application Data
(63) Continuation of application No. PCT/JP2018/000764, filed on Jan. 15, 2018.

(30) Foreign Application Priority Data
Jan. 17, 2017 (JP) 2017-005751

(51) Int. Cl. G02F 1/1333; G02F 1/1339

(52) U.S. Cl. CPC G02F 1/133305; G02F 1/133711; G02F 2201/501; G02F 1/1339

(57) ABSTRACT

An object of the present invention is to provide a fluid cell which can curb blending of a gas into a fluid layer even in a case where a plastic substrate is greatly deformed such that the plastic substrate stretches or shrinks, a three-dimensional fluid cell formed of the fluid cell, and a method for manufacturing a three-dimensional fluid cell. The fluid cell of the embodiment of the present invention is a fluid cell including a first plastic substrate, a first conductive layer, a fluid layer, a second conductive layer, and a second plastic substrate in this order, and further including a polymer layer between the first plastic substrate and the fluid layer, and a polymer layer between the second plastic substrate and the fluid layer, in which at least one of the first plastic substrate or the second plastic substrate is a heat-shrinkable film that satisfies a heat shrinkage rate of 5% to 75%, and a permeability coefficient of oxygen in the polymer layer is 50 cc·mm/m²·day·atm or less.

### CROSS-REFERENCE TO RELATED APPLICATIONS

This application is a Continuation of PCT International Application No. PCT/JP2018/000764 filed on Jan. 15, 2018, which claims priority under 35 U.S.C. § 119(a) to Japanese Patent Application No. 2017-005751 filed on Jan. 17, 2017. The above application is hereby expressly incorporated by reference, in its entirety, into the present application.

### BACKGROUND OF THE INVENTION

### 1. Field of the Invention

The present invention relates to a fluid cell, a three-dimensional fluid cell, and a method for manufacturing a three-dimensional fluid cell.

### 2. Description of the Related Art

Recently, various plastic substrates have been examined as a replacement for a glass substrate of a device such as a liquid crystal display device.

In addition, it has been known that plastic substrates have inferior gas barrier properties for shielding oxygen and moisture as compared with glass substrates, and thus a gas barrier layer is used in combination for sealing.

As such a gas barrier layer, a gas barrier film having an organic layer and an inorganic layer has been examined (for example, JP2011-051220A).

### SUMMARY OF THE INVENTION

However, it has been found that in a case of using plastic substrates, although plastic substrates can be used for a flexible display and the like which are attracting attention recently, a degree of flexibility required for a liquid crystal cell becomes much higher, and therefore, in a case of forming a curved surface in larger curvature by stretching, shrinkage, bending, or the like, there is a problem of a deterioration in a display performance because a gas (for example, air or the like) generated from the outside or the inside of the plastic substrate infiltrates into a liquid crystal layer.

In addition, it has been found that a gas barrier layer has a certain effect of preventing a gas from blending into a liquid crystal layer, but because a laminate is formed of an organic layer and an inorganic layer, the inorganic layer cannot follow elongation and contraction in a case of forming a curved surface, and therefore cracks occur as a result.

An object of the present invention is to provide a fluid cell which can curb blending of a gas into a fluid layer even in a case where a plastic substrate is greatly deformed such that the plastic substrate stretches or shrinks, a three-dimensional fluid cell formed of the fluid cell, and a method for manufacturing a three-dimensional fluid cell.

The inventors of the present invention have conducted intensive studies to achieve the above object, and as a result, have found that, in a fluid cell, by providing a polymer layer that has a specific permeability coefficient of oxygen between a predetermined plastic substrate and a predetermined fluid layer, a gas is not blended into the fluid layer even in a case where the plastic substrate is greatly deformed, and therefore a display performance as a fluid cell (particularly a liquid crystal cell) can be prevented from deteriorating.

That is, it has been found that the above-described object can be achieved with the following configuration.

[1] A fluid cell comprising: a first plastic substrate; a first conductive layer; a fluid layer; a second conductive layer; a second plastic substrate in this order; a polymer layer between the first plastic substrate and the fluid layer; and a polymer layer between the second plastic substrate and the fluid layer, in which at least one of the first plastic substrate or the second plastic substrate is a heat-shrinkable film that satisfies a heat shrinkage rate of 5% to 75%, and a permeability coefficient of oxygen in the polymer layer is 50 cc·mm/m²·day·atm or less.

[2] The fluid cell according to [1], in which a moisture content of the polymer layer is less than 10% by mass.

[3] The fluid cell according to [1] or [2], in which a thickness of the polymer layer is 100 μm or less.

[4] The fluid cell according to any one of [1] to [3], further comprising: an alignment layer between the first conductive layer and the fluid layer; and an alignment layer between the second conductive layer and the fluid layer,

in which the fluid layer is a liquid crystal layer formed by using a liquid crystal composition that contains a liquid crystal compound.

[5] A three-dimensional fluid cell which is formed by dimensionally changing the fluid cell according to any one of [1] to [4] at a rate of 5% to 75%.

[6] A three-dimensional fluid cell comprising: a first plastic substrate; a first conductive layer; a fluid layer; a second conductive layer; a second plastic substrate in this order; a polymer layer between the first plastic substrate and the fluid layer; and a polymer layer between the second plastic substrate and the fluid layer, in which a permeability coefficient of oxygen in the polymer layer is 50 cc·mm/m²·day·atm or less.

[7] A method for manufacturing a three-dimensional fluid cell which is produced by using a laminate including a first plastic substrate, a first conductive layer, a fluid layer, a second conductive layer, and a second plastic substrate in this order, and further including a polymer layer between the first plastic substrate and the fluid layer, and a polymer layer between the second plastic substrate and the fluid layer, in which at least one of the first plastic substrate or the second plastic substrate is a heat-shrinkable film that satisfies a heat shrinkage rate of 5% to 75%, and a permeability coefficient of oxygen in the polymer layer is 50 cc·mm/m²·day·atm or less, the method comprising, in this order:

a laminate production step of producing the laminate;

a two-dimensional fluid cell production step of sealing the fluid layer to produce a two-dimensional fluid cell; and

a three-dimensional processing step of heating and three-dimensionally processing the two-dimensional fluid cell to produce the three-dimensional fluid cell.

[8] The method for manufacturing a three-dimensional fluid cell according to [7], in which the heat-shrinkable film is an unstretched thermoplastic resin film.

[9] The method for manufacturing a three-dimensional fluid cell according to [7], in which the heat-shrinkable film is a thermoplastic resin film stretched within a range of greater than 0% and 300% or lower.

[10] The method for manufacturing a three-dimensional fluid cell according to any one of [7] to [9], in which both of the first plastic substrate and the second plastic substrate are the heat-shrinkable film that satisfies the heat shrinkage rate of 5% to 75%.

[11] The method for manufacturing a three-dimensional fluid cell according to any one of [7] to [10], in which the three-dimensional processing step is a three-dimensional processing step involving shrinkage of the heat-shrinkable film due to heating.

According to the present invention, it is possible to provide a fluid cell which can curb blending of a gas into a fluid layer even in a case where a plastic substrate is greatly deformed such that the plastic substrate stretches or shrinks, a three-dimensional fluid cell formed of the fluid cell, and a method for manufacturing a three-dimensional fluid cell.

### BRIEF DESCRIPTION OF THE DRAWINGS

FIG. 1 is a cross-sectional view schematically illustrating an aspect of a fluid cell of the embodiment of the present invention.

FIG. 2 is a cross-sectional view schematically illustrating another aspect of the fluid cell of the embodiment of the present invention.

FIG. 3 is a top view schematically illustrating still another aspect of the fluid cell of the embodiment of the present invention.

FIG. 4 is a top view schematically illustrating still another aspect of the fluid cell of the embodiment of the present invention.

FIG. 5 is a top view schematically illustrating an aspect of a fluid cell precursor used in the present invention.

FIG. 6 is a top view schematically illustrating an aspect of a fluid cell unit used in the present invention.

FIG. 7 is a top view schematically illustrating still another aspect of the fluid cell of the embodiment of the present invention.

FIG. 8 is a top view schematically illustrating an aspect of a heat source used in the present invention.

### DESCRIPTION OF THE PREFERRED EMBODIMENTS

Hereinafter, the present invention will be described in detail.

The following description of constituent requirements is based on typical embodiments of the invention, but the invention is not limited thereto.

In this specification, a numerical value range expressed using “to” means a range including numerical values before and after “to” as a lower limit value and an upper limit value.

In addition, in the present specification, “cutting” includes “punching,” “cutting out,” and the like.

Furthermore, in the present specification, “sealing” means a process in which a fluid in a fluid layer is sealed so that the fluid does not leak. However, in a case where a “sealing portion” or the like is referred to in the description of the present specification, and in a case where this sealing portion is produced, a fluid does not necessarily have to be sealed. In a case where a final plastic cell is produced, it is sufficient as long as a fluid layer is sealed.

[Fluid Cell]

A fluid cell of the embodiment of the present invention includes a first plastic substrate, a first conductive layer, a fluid layer, a second conductive layer, and a second plastic substrate in this order; and further includes a polymer layer between the first plastic substrate and the fluid layer, and a polymer layer between the second plastic substrate and the fluid layer.

In addition, in the fluid cell of the embodiment of the present invention, at least one of the first plastic substrate or the second plastic substrate is a heat-shrinkable film that satisfies a heat shrinkage rate of 5% to 75%.

Furthermore, in the fluid cell of the embodiment of the present invention, a permeability coefficient of oxygen in the polymer layer is 50 cc·mm/m²·day·atm or less.

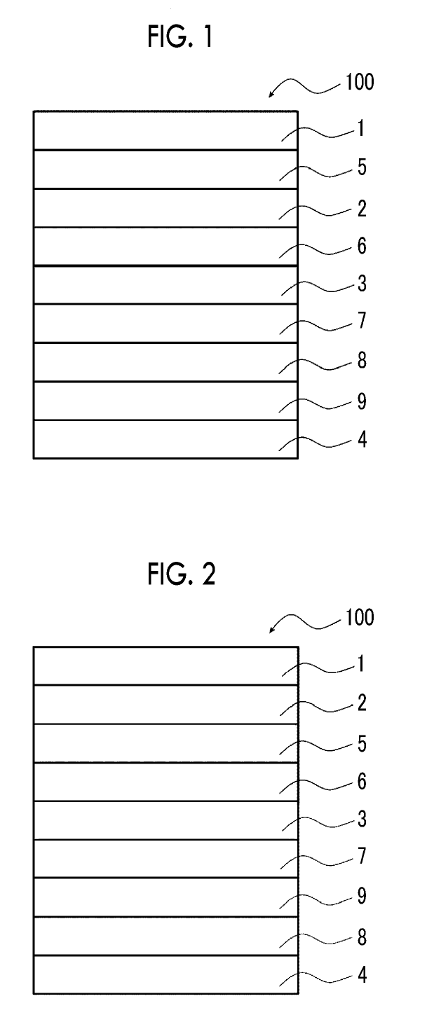

FIG. 1 and FIG. 2 show an example of a preferred embodiment of the fluid cell of the embodiment of the present invention.

A fluid cell 100 shown in FIG. 1 includes a first plastic substrate 1, a first conductive layer 5, a fluid layer 3, a second conductive layer 9, and a second plastic substrate 4 in this order; and further includes a polymer layer 2 between the first plastic substrate 1 and the fluid layer 3, and a polymer layer 8 between the second plastic substrate 4 and the fluid layer 3.

Meanwhile, FIG. 2 shows a fluid cell having an aspect in which a laminate position of the polymer layer 2 and the conductive layer 5 are reversed, and a laminate position of the polymer layer 8 and the conductive layer 9 are reversed in the fluid cell 100 shown in FIG. 1.

In addition, in the fluid cell 100 shown in FIG. 1 and FIG. 2, at least one of the first plastic substrate 1 or the second plastic substrate 4 is a heat-shrinkable film that satisfies a heat shrinkage rate of 5% to 75%.

Furthermore, in the fluid cell 100 shown in FIG. 1 and FIG. 2, a permeability coefficient of oxygen in the polymer layer 2 and the polymer layer 8 is 50 cc·mm/m²·day·atm or less.

As described above, in the fluid cell of the embodiment of the present invention, by providing a polymer layer that has a specific permeability coefficient of oxygen between a predetermined plastic substrate and a predetermined fluid layer, it is possible to curb blending of a gas into a fluid layer even in a case where a plastic substrate is greatly deformed.

The reason why such effects are exhibited is not elucidated in detail. The inventors of the present invention speculate the reason as follows.

In other words, the reason is considered as follows. In the present invention, at least one of the first plastic substrate or the second plastic substrate is a heat-shrinkable film that satisfies a heat shrinkage rate of 5% to 75%, and a permeability coefficient of oxygen in the polymer layer is 50 cc·mm/m²·day·atm or less. Accordingly, even in a case where the plastic substrate is greatly deformed, the polymer layer follows elongation and contraction, and therefore occurrence of cracks can be curbed, and a gas barrier effect by the polymer layer can be secured even at a deformed portion.

Next, each configuration of the fluid cell of the embodiment of the present invention will be described in detail.

The first plastic substrate and the second plastic substrate will be simply described as the “plastic substrate” when a distinction therebetween is not particularly required. The first conductive layer and the second conductive layer will be simply described as the “conductive layer” when a distinction therebetween is not particularly required.

[Plastic Substrate]

The plastic substrate of the fluid cell of the embodiment of the present invention is not particularly limited, but a thermoplastic resin is preferably used, because dimensional changes such as stretching and shrinkage are locally generated in a case of three-dimensionally forming the fluid cell to be described later.

In addition, as the thermoplastic resin, it is preferable to use a polymer resin having excellent optical transparency, mechanical strength, heat stability, and the like.

Examples of a polymer contained in the plastic substrate include a polycarbonate-based polymer; a polyester-based polymer such as polyethylene terephthalate (PET); an acrylic-based polymer such as polymethyl methacrylate (PMMA); a styrene-based polymer such as polystyrene, and a styrene-acrylonitrile copolymer (AS resin); and the like.

Examples thereof further include a polyolefin such as polyethylene and polypropylene; a polyolefin-based polymer such as a norbornene-based resin and an ethylene-propylene copolymer; an amide-based polymer such as a vinyl chloride-based polymer, nylon, and an aromatic polyamide; an imide-based polymer; a sulfone-based polymer; a polyethersulfone-based polymer; a polyether ether ketone-based polymer; a polyphenylene sulfide-based polymer; a vinylidene chloride-based polymer; a vinyl alcohol-based polymer; a vinyl butyl-based polymer; an arylate-based polymer; a polyoxymethylene-based polymer; an epoxy-based polymer; a cellulose-based polymer represented by triacetylcellulose; a copolymer copolymerized with monomer units of these polymers; and the like.

Examples of the plastic substrate also include a substrate formed by mixing two or more kinds of the polymers mentioned above as examples.

<Heat-Shrinkable Film>

In the present invention, in order to realize three-dimensional formability with a high degree of freedom, at least one of the first plastic substrate or the second plastic substrate is a heat-shrinkable film that satisfies a heat shrinkage rate of 5% to 75%. It is preferable that both of the first plastic substrate and the second plastic substrate be a heat-shrinkable film that satisfies a heat shrinkage rate of 5% to 75%.

<<Heat Shrinkage Rate>>

The heat shrinkage rate of the heat-shrinkable film used in the present invention is 5% to 75%, preferably 7% to 60%, and more preferably 10% to 45%.

In the heat-shrinkable film used in the present invention, the maximum heat shrinkage rate in an in-plane direction of the heat-shrinkable film is preferably 5% to 75%, more preferably 7% to 60%, and even more preferably 10% to 45%. In a case where stretching is performed as means for shrinkage, the in-plane direction in which the maximum heat shrinkage rate is shown substantially coincides with a stretching direction.

In the heat-shrinkable film used in the present invention, the heat shrinkage rate in a direction perpendicular to the in-plane direction in which the maximum heat shrinkage rate is shown is preferably 0% to 5%, and more preferably 0% to 3%.

A measurement sample is cut out every 5° in the measurement of a heat shrinkage rate under conditions to be described later, heat shrinkage rates in an in-plane direction of all of the measurement samples are measured, and the in-plane direction in which the maximum heat shrinkage rate is shown is specified by a direction in which the maximum measurement value is shown.

In the present invention, the heat shrinkage rate is a value measured under the following conditions.

To measure the heat shrinkage rate, a measurement sample having a length of 15 cm and a width of 3 cm with a long side in a measurement direction was cut out, and 1 cm-squares were stamped on one film surface in order to measure the film length. A point separated from an upper part of a long side of 15 cm by 3 cm on a central line having a width of 3 cm was set as A, a point separated from a lower part of the long side by 2 cm was set as B, and a distance AB of 10 cm between the points was defined as an initial film length L₀. The film was clipped up to 1 cm away from the upper part of the long side with a clip having a width of 5 cm and hung from the ceiling of an oven heated to a glass transition temperature (Tg) of the film. In this case, the film was put into a tension-free state while not being weighted. The entire film was sufficiently and uniformly heated, and after 5 minutes, the film was taken out of the oven for each clip to measure a length L between the points A and B after the heat shrinkage, and a heat shrinkage rate was obtained through Expression 1.

Heat shrinkage rate (%)=100×(L₀−L)/L₀ (Expression 1)

<<Glass Transition Temperature (Tg)>>

A Tg of the heat-shrinkable film used in the present invention can be measured by using a differential scanning calorimeter (DSC).

Specifically, the measurement was performed using a differential scanning calorimeter DSC7000X manufactured by Hitachi High-Tech Science Corporation under conditions of a nitrogen atmosphere and a rate of temperature increase of 20° C./min, and a temperature at a point where tangents of respective DSC curves at a peak top temperature of a time differential DSC curve (DDSC curve) of the obtained result and at a temperature of (peak top temperature−20° C.) intersected was set as a Tg.

{Stretching Step}

The heat-shrinkable film used in the present invention may be an unstretched thermoplastic resin film, but preferably a stretched thermoplastic resin film.

A stretching ratio is not particularly limited, but is preferably greater than 0% and 300% or less. A stretching ratio is more preferably greater than 0% and 200% or less, and is even more preferably greater than 0% and 100% or less, from the viewpoint of a practical stretching step.

Stretching may be performed in a film transport direction (longitudinal direction), in a direction perpendicular to the film transport direction (transverse direction), or in both of the directions.

A stretching temperature is preferably around a glass transition temperature Tg of the heat-shrinkable film to be used, and is more preferably Tg±0° C. to 50° C., is even more preferably Tg±0° C. to 40° C., and is particularly preferably Tg±0° C. to 30° C.

In the present invention, a film may be biaxially stretched simultaneously or sequentially in the stretching step. In a case of sequential biaxial stretching, a stretching temperature may be changed for each stretching in each direction.

In a case of sequential biaxial stretching, it is preferable that the film is first stretched in a direction parallel to the film transport direction, and then stretched in a direction perpendicular to the film transport direction. A stretching temperature range in which the sequential stretching is performed is more preferably the same as a stretching temperature range in which the simultaneous biaxial stretching is performed.

[Polymer Layer]

The polymer layers of the fluid cell of the embodiment of the present invention are provided between the first plastic substrate and the fluid layer, and between the second plastic substrate and the fluid layer, respectively. In the polymer layers, a permeability coefficient of oxygen in the polymer layer is 50 cc·mm/m²·day·atm or less.

In the present invention, a permeability coefficient of oxygen in the polymer layer is preferably 20 cc·mm/m²·day·atm or less, is more preferably 0.1 to 20 cc·mm/m²·day·atm, and is even more preferably 0.1 to 5 cc·mm/m²·day·atm.

A permeability coefficient of oxygen refers to a value measured by a method described in paragraphs [0011] to [0019] of JP2005-181179A under measurement conditions of 25° C. and a relative humidity of 50%. A permeability coefficient of oxygen (cc·mm/m²·day·atm) represents an amount of gas permeated per day (24 hours) based on a film area of 1 m² and a pressure of 1 atm with a thickness of a polymer layer converted to 1 mm.

In the present invention, a moisture content of the polymer layer is preferably less than 10% by mass, is more preferably 7% by mass or less, and is even more preferably 0.05% to 4% by mass, because of a reason that blending of a gas into a fluid layer can be further curbed.

A moisture content is a value measured by using a Karl Fischer moisture meter after conditioning at 25° C. and a relative humidity of 10% for 24 hours.

Preferred examples of constituent materials of the polymer layer include a thermoplastic resin having gas barrier properties, a thermosetting resin having gas barrier properties, and the like.

<Thermoplastic Resin>

Examples of a thermoplastic resin having gas barrier properties include a water-soluble polymer compound.

Specific examples of water-soluble polymer compounds include water-soluble polymers such as polyvinyl alcohol (PVA), vinyl alcohol-ethylene copolymer, vinyl alcohol-vinyl phthalate copolymer, vinyl acetate-vinyl alcohol-vinyl phthalate copolymer, vinyl acetate-crotonic acid copolymer, polyvinyl pyrrolidone, acid celluloses, gelatin, gum arabic, poly(meth)acrylic acid, poly(meth)acrylic acid ester having a hydroxyl group, and polyacrylamide. One kind of these may be used alone or two or more kinds thereof may be used in combination.

Among these, a water-soluble polymer having a hydroxyl group is preferable, and polyvinyl alcohol (PVA) and a poly(meth)acrylic acid ester having a hydroxyl group are more preferable.

<Thermosetting Resin>

Examples of a thermosetting resin having gas barrier properties include an epoxy resin.

An epoxy resin may be any of a saturated or unsaturated aliphatic compound or alicyclic compound, an aromatic compound, or a heterocyclic compound. In a case of taking expression of a high degree of gas barrier properties into consideration, an epoxy resin containing an aromatic ring in the molecule is preferable.

Specific examples of an epoxy resin containing an aromatic ring in the molecule include at least one resin selected from an epoxy resin having a glycidyl amino group derived from metaxylylenediamine, an epoxy resin having a glycidyl amino group derived from 1,3-bis(aminomethyl) cyclohexane, an epoxy resin having glycidyl amino group derived from diaminodiphenylmethane, an epoxy resin having a glycidyl amino group and/or a glycidyloxy group derived from para-aminophenol, an epoxy resin having a glycidyloxy group derived from bisphenol A, an epoxy resin having a glycidyloxy group derived from bisphenol F, an epoxy resin having a glycidyloxy group derived from a phenol novolac, or an epoxy resins having a glycidyloxy group derived from resorcinol.

Among these, an epoxy resin having a glycidyl amino group derived from metaxylylene diamine is preferable.

In addition, as a thermosetting resin having gas barrier properties, a thermosetting resin obtained by curing an epoxy resin composition containing an amine curing agent together with the above-mentioned epoxy resin may be used.

As an amine curing agent, it is possible to use a curing agent used for general epoxy resins, such as polyaminoamides, epoxy resin amine adducts, aliphatic polyamines, modified polyamines, tertiary amines, hydrazides, and imidazoles. Among these, polyaminoamides and imidazoles are preferable.

For example, as a commercial product, MAXIVE manufactured by Mitsubishi Gas Chemical Co., Ltd., and the like can be preferably used.

In the present invention, a thickness of the polymer layer is preferably 100 μm or less, is more preferably 50 μm or less, and is even more preferably 0.5 to 15 pan, because the polymer layer easily follows elongation and contraction.

[Conductive Layer]

The conductive layer of the fluid cell of the embodiment of the present invention is a layer that has conductivity, and is disposed between the plastic substrate and the fluid layer (refers to the alignment layer in a case of having an optional alignment layer, and hereinafter, the same applies in this paragraph), that is, between the above-mentioned the plastic substrate and the polymer layer, or between the above-mentioned polymer layer and the fluid layer to be described later.

In the present invention, the phase “is conductive” means that a sheet resistance value is 0.1Ω/□ to 10,000Ω/□ and includes a layer generally called an electrical resistivity layer.

In a case where the conductive layer is used as an electrode of a flexible display device and the like, a sheet resistance value of a conductive layer is preferably low, and specifically, is preferably 300Ω/□ or lower, particularly preferably 200Ω/□ or lower, and most preferably 100Ω/□ or lower.

The conductive layer is preferably transparent.

In the present invention, the term “transparent” means that light transmittance is 60% to 99%.

The light transmittance of the conductive layer is preferably 75% or higher, particularly preferably 80% or higher, and most preferably 90% or higher.

Because the conductive layer follows shrinkage of the substrate, and therefore a short circuit in the conductive layer is unlikely to occur and a change in electric resistivity can be suppressed to be small, it is preferable that a heat shrinkage rate of the conductive layer be close to a heat shrinkage rate of a heat-shrinkable film as the above-described plastic substrate.

Specifically, a heat shrinkage of the conductive layer is preferably 50% to 150%, is more preferably 80% to 120%, and is even more preferably 90% to 110% with respect to a heat shrinkage rate of a heat-shrinkable film as the plastic substrate described above.

Examples of a material that can be used for the conductive layer include metal oxide (such as Indium Tin Oxide (ITO)); Carbon Nanotube (CNT), Carbon Nanobud (CNB), and the like; graphene; polymer conductors (such as polyacetylene, polypyrrole, polyphenol, polyaniline, and PEDOT/PSS); metal nanowires (such as silver nanowires and copper nanowires); metal mesh (such as silver mesh and copper mesh); and the like.

The term “PEDOT/PSS” refers to a polymer complex in which a polymer of 3,4-ethylenedioxythiophene (PEDOT) and a polymer of styrene sulfonic acid (PSS) coexist.

In addition, it is preferable that the conductive layer of the metal mesh is formed by dispersing conductive fine particles such as silver and copper in a matrix, rather than formed of only a metal, from the viewpoint of a heat shrinkage rate.

[Fluid Layer]

The fluid layer of the fluid cell of the embodiment of the present invention is not particularly limited as long as the layer is a continuous body with fluidity, other than gas and plasma fluid.

Particularly preferable states of a substance are preferably a liquid and a liquid crystal. A fluid layer is preferably a liquid crystal layer formed by using a liquid crystal composition containing a liquid crystal compound.

In general, liquid crystal compounds can be classified into rod-like types and disk-like types according to shapes thereof. Liquid crystal compounds can be further classified into low molecular-types and high molecular-types. In general, high molecular-types refer to a compound having a degree of polymerization of 100 or more (Polymer physics and phase transition dynamics, Masao Doi, page 2, Iwanami Shoten, 1992). In the present invention, any liquid crystal compound can be used, but it is preferable to use a rod-like liquid crystal compound or a discotic liquid crystal compound (a disk-like liquid crystal compound). Two or more kinds of rod-like liquid crystal compounds, two or more kinds of disk-like liquid crystal compounds, or a mixture of a rod-like liquid crystal compound and a disk-like liquid crystal compound may be used. In order to fix the above-mentioned liquid crystal compound, it is more preferable to form a compound by using a rod-like liquid crystal compound or a disk-like liquid crystal compound having a polymerizable group, and it is even more preferable that a liquid crystal compound have two or more polymerizable groups in one molecule. In a case where the liquid crystal compound is a mixture of two or more kinds, it is preferable that at least one kind of liquid crystal compounds have two or more polymerizable groups in one molecule.

[Alignment Layer]

In the fluid cell of the embodiment of the present invention, it is preferable that an alignment layer be provided between the first conductive layer or polymer layer and the fluid layer, and between the second conductive layer or polymer layer and the fluid layer in a case where the above-mentioned fluid layer is a liquid crystal layer formed by using a liquid crystal composition containing a liquid crystal compound.

The alignment layer may be an alignment layer in which a liquid crystalline composition contained in the fluid layer is horizontally aligned, or may be an alignment layer in which the liquid crystalline composition contained in the fluid layer is vertically aligned when no voltage is applied.

A material and a processing method of the alignment layer are not particularly limited. It is possible to use various alignment layers such as an alignment layer formed of a polymer, an alignment layer that has been subjected to a silane coupling treatment, an alignment layer formed of a quaternary ammonium salt, an alignment layer in which silicon oxide is vapor deposited in an oblique direction, and an alignment layer using photoisomerization. In addition, as a surface treatment for the alignment layer, a rubbing treatment, or a surface treatment by energy ray irradiation, light irradiation, or the like may be used.

As an alignment layer formed of a polymer, any of a layer formed of polyamic acid or polyimide; a layer formed of modified or non-modified polyvinyl alcohol; a layer formed of modified or non-modified polyacrylic acid; a layer formed of a (meth)acrylic acid copolymer containing any of a repeating unit represented by General Formula (I), a repeating unit represented by General Formula (II), and a repeating unit represented by General Formula (III) is preferable.

The term “(meth)acrylic acid” is a notation representing acrylic acid or methacrylic acid.

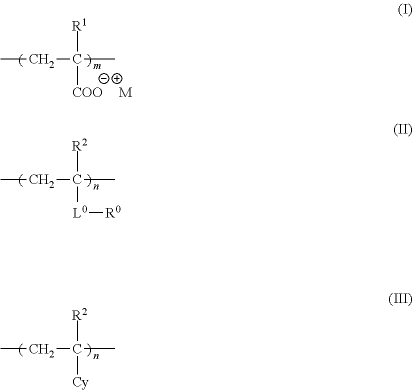

In General Formulas (I) to (III), R¹ and R² are each independently a hydrogen atom, a halogen atom, or an alkyl group having 1 to 6 carbon atoms; M is a proton, an alkali metal ion, or an ammonium ion; L° is a divalent linking group selected from the group consisting of —O—, —CO—, —NH—, —SO₂—, an alkylene group, an alkenylene group, an arylene group, and a combination thereof; R⁰ is a hydrocarbon group having 10 to 100 carbon atoms or a fluorine atom-substituted hydrocarbon group having 1 to 100 carbon atoms; Cy is an aliphatic ring group, an aromatic group, or a heterocyclic group, and particularly preferably has a carbazole group; m is 10 to 99 mol %; and n is 1 to 90 mol %.

Among these, it is preferable to use an alignment layer containing any of polyimide, a compound represented by General Formulas (I) to (III), and a silane coupling agent from the viewpoints of alignment ability, durability, insulation properties, and costs. It is particularly preferable to use an alignment layer containing any of polyimide, and a compound that is represented by General Formulas (I) to (III) and has a carbazole group.

In addition, as the alignment layer, a photo alignment layer which can perform alignment processing of liquid crystal by irradiation of polarized and non-polarized ultraviolet (UV) light may be used.

[Migration Inhibitor]

In a case where the conductive layer of the fluid cell of the embodiment of the present invention is formed of metal nanowire and/or metal mesh, a migration inhibitor is preferably contained in the conductive layer and/or the polymer layer which is directly in contact with the conductive layer.

As the migration inhibitor, known migration inhibitors can be suitability used, and examples thereof include compounds disclosed in JP2009-188360A, JP2012-231035A, JP2013-125797A, and JP2014-133857A.

[Sealing Portion]

The fluid cell of the embodiment of the present invention preferably has sealing portions for sealing the above-mentioned fluid layer, from the viewpoint of further curbing blending of a gas into the fluid layer.

The sealing portions may be provided in one or two or more portions. At least one sealing portion is preferably a sealing portion obtained by heat fusion welding of the first plastic substrate and the second plastic substrate described above.

The sealing portion means a portion other than the first plastic substrate and the second plastic substrate described above, among portions that surrounds the fluid layer in the fluid cell. However, in a case where the sealing portion is formed by heat fusion welding of the first plastic substrate and the second plastic substrate described above, because the plastic substrate and the sealing portion are not distinguished depending on materials, a region that is projecting or is recessed in a vertical direction with respect to the plane of the plastic substrate is referred to as a sealing portion.

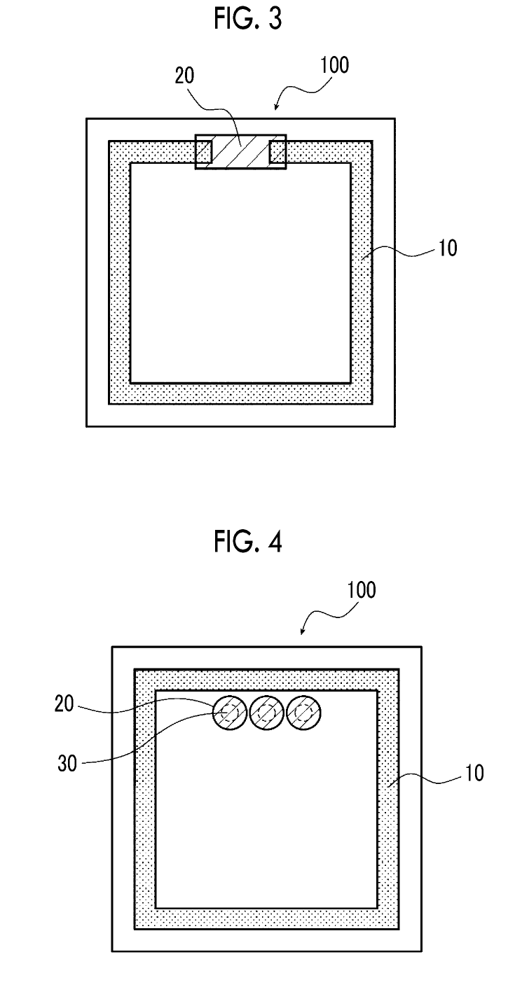

Examples of specific aspects of the sealing portion include an aspect that has a first sealing portion 10 and a second sealing portion 20, such as a fluid cell 100 shown in FIG. 3.

<First Sealing Portion>

A first sealing portion is preferably a sealing portion obtained by heat fusion welding of the first plastic substrate and the second plastic substrate described above, and preferably accounts for 80% to 99.5%, more preferably accounts for 83% to 99.5%, and even more preferably accounts for 87% to 99.5% with respect to the entire volume of the sealing portion.

In a case where the first sealing portion accounts for 80% or more, it is possible to curb the fluid layer from leaking before forming a second sealing portion to be described later. In addition, in a case where the first sealing portion accounts for 99.5% or less, and in a case where bubbles exist in the fluid layer after forming the first sealing portion, it is possible to form a second sealing portion after removing the bubbles.

A method of heat fusion welding is not particularly limited as long as a method of supplying energy required for heat fusion welding to a plastic substrate is used. Specific examples thereof include a method of bringing a high-temperature metal element into contact with a plastic substrate, a method of focusing a COx laser and applying the COx laser to a plastic substrate, a method of applying ultrasonic waves to a plastic substrate, and the like.

<Second Sealing Portion>

The second sealing portion is formed in a region where the first sealing portion is not formed. A method of forming the second sealing portion is not particularly limited. The second sealing portion may be a sealing obtained by heat fusion welding, or may be a sealing obtained by using a sealing material or an adhesive.

The second sealing portion may be formed such that, after forming the first sealing portion, an unsealed portion of the fluid layer is sealed and a partial region comes into contact with the first sealing portion.

In addition, the first sealing portion and the second sealing portion may be formed as follows. As shown in FIG. 4, after sealing the fluid layer with the first sealing portion 10, a through-hole 30 that leads to the conductive layer is formed on the plastic substrate or the first sealing portion, and the second sealing portion 20 is formed to cover this hole. A method of forming the through-hole 30 is not particularly limited, and various known methods can be used.

In addition, from the viewpoint of facilitating the escape of air bubbles, the second sealing portion may be formed in a state in which an internal pressure of a plastic cell is increased. Examples of methods of raising an internal pressure include a method of pressing a plastic cell uniformly, a method of relatively raising an internal pressure by reducing a pressure of a system including a plastic cell, and the like.

[Electrode]

The fluid cell of the embodiment of the present invention may have an electrode connected to the conductive layer in order to apply a driving voltage.

Examples of methods of attaching an electrode include a method of producing a plastic cell after attaching an electrode to a conductive layer on a plastic substrate; a method of connecting a lead terminal by using a conductive tape or a conductive material, such as silver paste, with a conductive layer after producing a plastic cell; a method of attaching an electrode while covering an unsealed portion by forming a second sealing portion after forming a first sealing portion by heat fusion welding and connecting a lead terminal to a conductive layer of the unsealed portion; and the like.

The fluid cell of the embodiment of the present invention is preferably an aspect in which the above-described fluid layer is a liquid crystal layer, that is, a liquid crystal cell.

The liquid crystal cell includes a liquid crystal cell used in a liquid crystal display device that is used in a flat screen TV, a monitor, a laptop computer, a mobile phone, and the like, and includes a liquid crystal cell used in a dimming device for changing the strength and weakness of light, which is applied to interior, a building material, a vehicle, and the like.

In addition, regarding drive modes of the liquid crystal cell, various methods can be used including a horizontal alignment mode (In-Plane-Switching: IPS), a vertical alignment mode (Vertical Alignment: VA), a twisted nematic mode (Twisted Nematic: TN), and a super twisted nematic mode (Super Twisted Nematic: STN).

Furthermore, the fluid cell of the embodiment of the present invention may have a rectangular planar shape. A shape thereof may be a square or a rectangle. A size of the fluid cell of the embodiment of the present invention is not particularly limited.

In addition, a planar shape of the fluid cell of the embodiment of the present invention may be a shape other than a rectangle. For example, a shape thereof may be a circle, an ellipse, a triangle, or a polygonal shape having five or more sides, or may have a free shape obtained by combining straight lines and curves. In a case where surroundings of a plastic cell are sealed, a shape of the fluid cell of the embodiment of the present invention may be an annular structure (a so-called donut shape) in which a through-hole forms a central portion.

Because the fluid cell of the embodiment of the present invention can use a long film as a plastic substrate, as a plastic substrate, it is also possible to adopt a form of a roll wound up in a longitudinal direction after a fluid cell is made. Such an adoption can contribute to packaging, shipping, transportation, and the like of the plastic cell of the embodiment of the present invention.

[Three-Dimensional Fluid Cell]

A three-dimensional fluid cell according to a first aspect of the present invention is a three-dimensional fluid cell that is formed by dimensionally changing the fluid cell of the embodiment of the present invention at a rate of 5% to 75%.

A dimensional change means a rate accounting for a difference before and after change when a dimension (which refers to an area of a main surface of the fluid cell, and hereinafter, the same applies) before change is 100. For example, 30% dimensional change means a state in which the dimension after change is 130 and a difference before and after change is 30 when the dimension before change is 100.

In addition, the three-dimensional fluid cell according to the first aspect of the present invention can be produced by three-dimensionally forming the fluid cell of the embodiment of the present invention.

The three-dimensional formation means that, for example, the three-dimensional liquid crystal cell is formed by shrinkage after the fluid cell of the embodiment of the present invention is formed into a tubular shape. For example, by shrinking and forming so as to follow a body shaped like a beverage bottle, a display device or a dimming device can be installed on the bottle, or a display device covering the vicinity of the cylindrical structure can be realized.

A three-dimensional fluid cell according to a second aspect of the present invention is a three-dimensional fluid cell that includes a first plastic substrate, a first conductive layer, a fluid layer, a second conductive layer, and a second plastic substrate in this order, and further includes a polymer layer between the first plastic substrate and the fluid layer, and a polymer layer between the second plastic substrate and the fluid layer, in which a permeability coefficient of oxygen in the polymer layer is 50 cc·mm/m²·day·atm or less.

Here, the same applies to all of the first conductive layer, the fluid layer, the second conductive layer, and the polymer layer included in the three-dimensional fluid cell according to the second aspect of the present invention, as those described in the above-described fluid cell of the embodiment of the present invention. In addition, the same applies to both of the first plastic substrate and the second plastic substrate included in the three-dimensional fluid cell according to the second aspect of the present invention, as those described in the above-described fluid cell of the embodiment of the present invention, except that a heat shrinkage rate is not limited.

[Method for Manufacturing Three-Dimensional Fluid Cell]

A method for manufacturing a three-dimensional fluid cell of the embodiment of the present invention is a method for manufacturing a three-dimensional fluid cell, in which a three-dimensional fluid cell is produced by using the above-described fluid cell of the embodiment of the present invention, that is, a laminate that includes a first plastic substrate, a first conductive layer, a fluid layer, a second conductive layer, and a second plastic substrate in this order, and further includes a polymer layer between the first plastic substrate and the fluid layer, and a polymer layer between the second plastic substrate and the fluid layer, in which at least one of the first plastic substrate or the second plastic substrate is a heat-shrinkable film that satisfies a heat shrinkage rate of 5% to 75%, and a permeability coefficient of oxygen in the polymer layer is 50 cc·mm/m²·day·atm or less.

In addition, the method for manufacturing a three-dimensional fluid cell of the embodiment of the present invention includes, in this order, a laminate production step of producing the laminate; a two-dimensional fluid cell production step of sealing the fluid layer to produce a two-dimensional fluid cell; and a three-dimensional processing step of heating and three-dimensionally processing the two-dimensional fluid cell to produce the three-dimensional fluid cell.

[Laminate Production Step]

The laminate production step of the method for manufacturing a three-dimensional fluid cell of the embodiment of the present invention is a step of producing the above-described fluid cell of the embodiment of the present invention.

Specifically, the laminate production step is a step of producing a laminate that has a first plastic substrate, a first conductive layer, a polymer layer, an optional alignment layer, a fluid layer, an optional alignment layer, a polymer layer, a second conductive layer, and a second plastic substrate in this order; or a laminate that has a first plastic substrate, a polymer layer, a first conductive layer, an optional alignment layer, a fluid layer, an optional alignment layer, a second conductive layer, a polymer layer, and a second plastic substrate in this order.

Examples of methods of disposing members so that a laminate has the above-mentioned lamination order include a method of disposing a second plastic substrate on which a conductive layer, a polymer layer, and an alignment layer are disposed, after disposing a fluid layer on the alignment layer of a first plastic substrate on which a conductive layer, a polymer layer, and an alignment layer are disposed; a method of disposing a fluid layer in a gap after a first plastic substrate on which a conductive layer, a polymer layer, and an alignment layer are disposed, and a second plastic substrate on which a conductive layer, a polymer layer, and an alignment layer are disposed are disposed to be separated from each other with a gap therebetween; and the like.

A method of disposing a liquid crystal layer is not particularly limited, and various known methods such as coating and injection utilizing capillary phenomenon can be used.

In the present invention, because heat shrinkage is performed by heating for three-dimensional processing in the three-dimensional processing step to be described later, in the laminate production step, for example, as temperature conditions in a case of heating and drying, a temperature is preferably a temperature that enables heat shrinkage, that is, a temperature of 60° C. or higher and 140° C. or lower. A temperature is more preferably 80° C. or higher and 130° C. or lower, and is even more preferably 90° C. or higher and 130° C. or lower. A heating time is preferably a time in which deformation of a heat-shrinkable film does not occur due to extreme heating while heat is sufficiently spread uniformly, that is, 3 seconds to 30 minutes. A heating time is more preferably 10 seconds or longer and 10 minutes or shorter, and is more preferably 30 seconds or longer and 5 minutes or shorter.

[Two-Dimensional Liquid Crystal Cell Production Step]

The two-dimensional liquid crystal cell production step of the method for manufacturing a three-dimensional fluid cell of the embodiment of the present invention is a step of sealing the fluid layer sandwiched between the two plastic substrates in the laminate produced in the laminate production step.

A method of sealing is not particularly limited. It is possible to use various methods such as a method of disposing a sealing material so as to fill a gap between end portions of two plastic substrates, and a method of heat fusion welding of end portions of two plastic substrates.

Sealing may be completed before the three-dimensional processing step to be described later. For example, other portions may be sealed in a state where an injection port of the liquid crystal layer is opened, and the injection port may be sealed after injecting the liquid crystal layer so as to perform sealing.

[Three-Dimensional Processing Step]

The three-dimensional processing step of the method for manufacturing a three-dimensional fluid cell of the embodiment of the present invention is a step of heating and three-dimensionally processing the two-dimensional fluid cell to produce the three-dimensional fluid cell.

In the three-dimensional processing step used in the present invention, a heat-shrinkable film is preferably shrunk and three-dimensional processed by heating.

As temperature conditions for heating the heat-shrinkable film, it is preferable that a temperature be equal to or less than (that is, 60° C. or higher and 260° C. or lower) a temperature at which the film melts while performing formation with a temperature exceeding a Tg of the film. A temperature is more preferably 80° C. or higher and 230° C. or lower, and is even more preferably 100° C. or higher and 200° C. or lower. A heating time is preferably a time in which decomposition of a film does not occur due to extreme heating while heat is sufficiently spread uniformly, that is, 3 seconds to 30 minutes. A heating time is more preferably 10 seconds or longer and 10 minutes or shorter, and is more preferably 30 seconds or longer and 5 minutes or shorter. A heat shrinkage rate of the film is preferably 5% or more and 75% or less in order to realize three-dimensional formability with a high degree of freedom. A heat shrinkage rate of the film is more preferably 7% or more and 60% or less, and is even more preferably 10% or more and 45% or less. In addition, a thickness of the heat-shrinkable film after shrinkage is not particularly limited, but is preferably 10 μm to 500 μm, and is more preferably 20 μm to 300 μm.

In realizing shrinkage behaviors as described above, some thermoplastic resins have exceptions that are difficult to shrink due to characteristics of the resin, such as crystallization. As an example, polyethylene terephthalate (PET) has a high ability to shrink in a case where PET is amorphous, but PET may be difficult to shrink in some cases while increasing thermal stability through a process of polymer chain alignment and crystal fixation by strong stretching. Some thermoplastic resins which are difficult to shrink due to such crystallization are not preferable.

In addition, it is also preferable to perform three-dimensional processing after forming a three-dimensional fluid cell precursor which is obtained by making a two-dimensional liquid crystal cell into a cylindrical shape.

A method of forming a two-dimensional liquid crystal cell into a cylindrical shape is not particularly limited. Examples thereof include a method of pressing sides facing each other after rounding a sheet-like two-dimensional liquid crystal cell. A shape of the inside of a cylindrical tube is not particularly limited, and may be circular or elliptical when viewed from top, or may be a free shape having a curved surface. In addition, it is preferable that all sides of the three-dimensional fluid cell precursor be sealed.

According to the method for manufacturing a three-dimensional fluid cell of the embodiment of the present invention, for example, by shrinking and forming so as to follow a body shaped like a beverage bottle, a display device or a dimming device can be installed on the bottle, or manufacture of a display device covering the vicinity of the cylindrical structure can be realized.

In the method for manufacturing a three-dimensional fluid cell of the embodiment of the present invention, it is preferable that a circumferential length L0 before shrinkage and a circumferential length L after shrinkage satisfy Equation 2.

5≤100×(L0−L)/L0≤75 (Equation 2)

In this case, a circumferential length L after shrinkage may be different circumferential lengths at a plurality of places as long as the above equation is satisfied. In other words, in the method for manufacturing a three-dimensional fluid cell of the embodiment of the present invention, it is possible to perform processing into a three-dimensionally formed body having a higher degree of freedom within a range satisfying the above equation.

In addition, it is sufficient as long as Equation 2 is satisfied for a part of regions of the three-dimensional fluid cell produced. It is preferable that Equation 2 is satisfied for all the regions.

In this forming process, by using the formed body that has a high degree of freedom and has a circumferential length smaller than the circumferential length L0 before shrinkage, the heat-shrinkable film used in the present invention shrinks toward the cylindrical inside, and therefore a pressure is applied to the cylindrical inside. However, even in a case where pressure is applied to a certain point of the liquid crystal layer within the sealed liquid crystal cell, regardless of a shape of the liquid crystal cell, the pressure is uniformly transmitted to all other regions of the liquid crystal layer (so-called Pascal's theorem). Therefore, the inside of the liquid crystal cell is uniformly pressed by film shrinkage, and a cell gap can be held constant. However, an aspect in which various spacers are disposed within a liquid crystal cell in advance to keep a cell gap constant is also a particularly preferable aspect.

[Cutting Step]

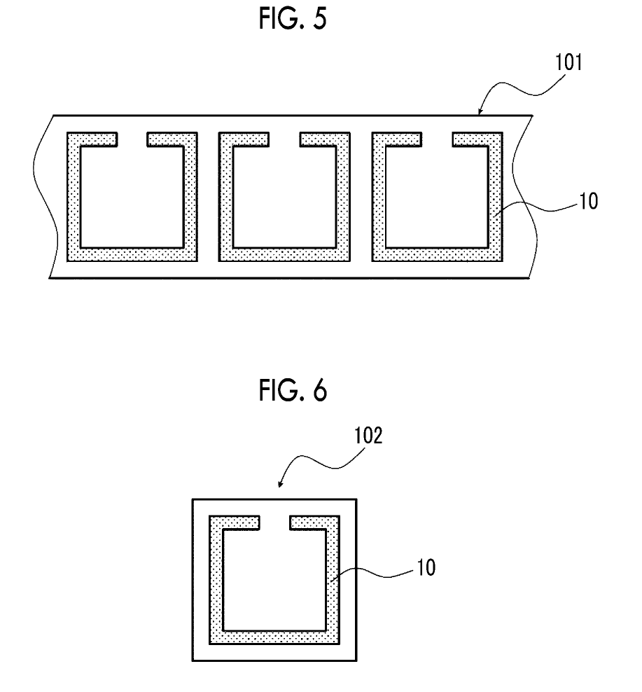

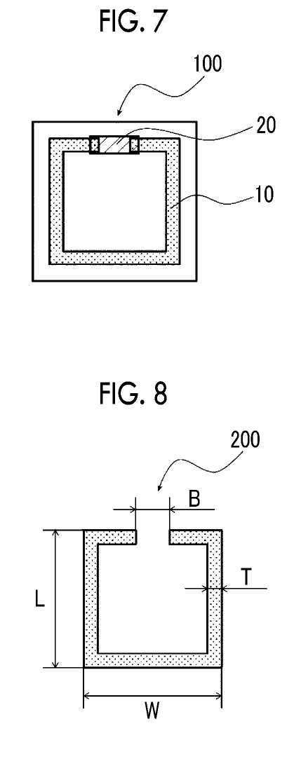

The method for manufacturing a three-dimensional fluid cell of the embodiment of the present invention may include a cutting step of cutting a fluid cell precursor to produce a fluid cell unit in the above-described laminate production step and two-dimensional liquid crystal cell generation step. For example, a cutting step may be a step in which after continuously forming the first sealing portion with respect to an elongated fluid cell precursor 101 as shown in FIG. 5, fluid cell precursors are respectively cut at an outer side of the first sealing portion to produce a fluid cell unit 102 having at least one first sealing portion 10 as shown in FIG. 6, and second sealing portions are formed in each fluid cell unit to produce a plurality of fluid cells 100 as shown in FIG. 7. In this case, after forming the first sealing portion, the first sealing portion may be wound once into a roll state.

### EXAMPLES

Hereinafter, the present invention will be described in detail with reference to examples. The materials, the reagents, the amounts of materials, the proportions thereof, the conditions, the operations, and the like which will be shown in the following examples can be appropriately modified within a range not departing from the gist of the present invention. Accordingly, the scope of the present invention is not limited to the following examples.

### Example 1

<Plastic Substrate Production>

Polycarbonate (PC-2151, thickness of 250 μm) manufactured by TEIJIN LIMITED. was pinched by a clip and stretched at a ratio of 20% in a film transport direction (Machine Direction: MD) and at a ratio of 100% in a direction (Transverse Direction: TD) perpendicular to the MD by using a tenter under conditions of a stretching temperature of 155° C. and of fixed end biaxial stretching, and therefore the plastic substrate was produced. At this time, the glass transition temperature (Tg) was 150° C., and the heat shrinkage rate in the TD measured by the above-described method was 40%.

In addition, the in-plane direction in which a heat shrinkage rate is maximum was substantially coincident with the TD direction, and a heat shrinkage rate in the MD direction perpendicular thereto was 6%.

<Production of Polymer Layer A>

A polymer layer-coating solution was prepared using the following formulation.

Formulation of polymer layer-coating solution

| | |
|---|---|
| The following BLEMMER GLM | 80 parts by mass |
| (manufactured by NOF CORPORATION) | |
| The following Aronix M-306 | 20 parts by mass |
| (manufactured by Toagosei Co., Ltd.) | |
| Photopolymerization initiator | 3 parts by mass |
| (IRGACURE 819 (manufactured by BASF SE)) | |
| The following surfactant A | 0.5 parts by mass |
| Ethanol | 200 parts by mass |

BLEMMER GLM 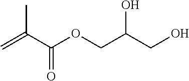
Aronix M-306 (a mixture of the following pentaerythritol triacrylate and the following pentaerythritol tetraacrylate) 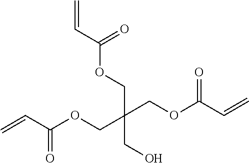 [SMILES: C=CC(=O)OCC(CO)(COC(=O)C=C)COC(=O)C=C] 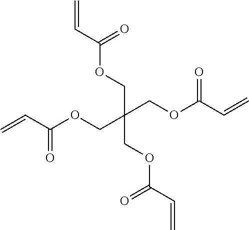 [SMILES: C=CC(=O)OCC(COC(=O)C=C)(COC(=O)C=C)COC(=O)C=C]
Surfactant A

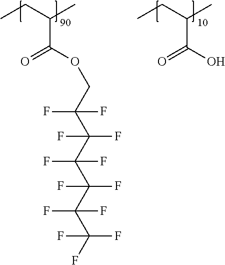

By using Bar Coater #20, the polymer layer-coating solution prepared was applied on the above-described plastic substrate at an application amount by which a film thickness becomes 10 μm, heated so that a film surface temperature became 50° C., and then dried for 1 minute. Thereafter, under a nitrogen purge with an oxygen concentration of 100 ppm or less, irradiation of 500 mJ/cm² of ultraviolet rays was carried out using an ultraviolet irradiation device so as to proceed the polymerization reaction, and therefore a polymer layer A was produced. An irradiation dose was measured at a wavelength of 365 nm. Mercury was used as a lamp.

A permeability coefficient of oxygen and a moisture content of the produced polymer layer A were measured by a method described below.

(Permeability Coefficient of Oxygen)

A permeability coefficient of oxygen is a value measured by a method described in JP2005-181179A under measurement conditions of 25° C. and a relative humidity of 50%.

Specifically, using a MODEL 3600 as an oximeter which is manufactured by Orbisphere Laboratories Corporation, a test piece cut into a diameter of 1.5 cm through silicon grease thinly applied to a polyfluoroalkoxy diaphragm (2956A, manufactured by Orbisphere Laboratories Corporation) was attached. An oxygen permeation amount was obtained from an oxygen reduction current output value in a steady state, and therefore an oxygen permeation rate was calculated by dividing the oxygen permeation amount by a measurement time. The conversion of the output current value into the oxygen permeation amount was obtained by creating a calibration curve by using a sample of which a permeation amount was known. In order to make it easy to compare characteristics between materials, the output current value was converted to a permeability coefficient of oxygen while taking a film thickness value into consideration.

A permeability coefficient of oxygen in the plastic substrate on which a polymer layer A was formed was 4.09 cc·mm/m²·day·atm. Based on a permeability coefficient of oxygen in polycarbonate itself, which is a plastic substrate, being 53 cc·mm/m²·day·atm, a permeability coefficient of oxygen in the polymer layer A alone was calculated from the following equation.

[Film thickness of polymer layer A/permeability coefficient of oxygen in polymer layer A]+[film thickness of plastic substrate/permeability coefficient of oxygen in plastic substrate]=[film thickness of (polymer layer A+plastic substrate)/permeability coefficient of oxygen in (polymer layer A+plastic substrate)]

A permeability coefficient of oxygen in the polymer layer A alone calculated by the above method was 0.4 cc·mm/m²·day·atm, as also shown in Table 1.

(Moisture Content)

A moisture content is a value calculated by the following method.

The polymer layer A was scrapped from the plastic substrate and conditioned at 25° C. and a relative humidity of 10% for 24 hours. A moisture content was measured using a device for measuring a small amount of moisture (AQ-2200, manufactured by Hiranuma Sangyo Co., Ltd.) and an automatic heating moisture vaporizer (SE-320, manufactured by Hiranuma Sangyo Co., Ltd.) according to the Karl Fischer method. The measured moisture content was divided by a sample mass to calculate the moisture content.

The moisture content of the polymer layer A calculated by the above method was 0.90% as shown in Table 1.

<Production of Conductive Layer>

On a surface of the polymer layer A produced as described above, a conductive layer formed of Ag nanowire was produced by using Ag nanowire using the method disclosed in Example 1 of US Patent App. No. 2013/0341074, and a laminate on which a plastic substrate formed of the stretched polycarbonate, and a conductive layer formed of the polymer layer A and Ag nanowire were laminated was produced. A coating film thickness of the conductive layer was 15 μm.

The laminate produced as above was cut to a square of 10 cm, and then light transmittance, a sheet resistance value, and haze were measured. As a result, the light transmittance was 90%, the sheet resistance value was 40Ω/□, and the haze was 0.70.

<Production of Alignment Layer>

By using Bar Coater #1.6, a polyamic acid alignment layer coating solution (JALS 684, manufactured by JSR Corporation) as a liquid crystal alignment agent was applied on the conductive layer of the laminated produced as above. Thereafter, drying was performed for 3 minutes at a point where a film surface temperature reached 80° C., and therefore an alignment layer was produced. At this time, a film thickness of the alignment layer was 60 nm.

Two sets of laminates in which the heat-shrinkable film (plastic substrate), the polymer layer A, the conductive layer, and the alignment layers, which were produced as above, were laminated in this order, were prepared as a roll having a length of 50 m.

<Production of Spacer Layer>

A spacer layer dispersion liquid was produced using the following formulation.

Formulation of spacer layer dispersion liquid

| | |
|---|---|
| Bead spacer SP-208 (manufactured | 100 parts by mass |
| by SEKISUI CHEMICAL CO., LTD.) | |
| Methyl isobutyl ketone | An amount such that a solid |
| | content is 0.2% by mass |

The spacer layer dispersion liquid produced was applied to the two sets of laminates in which the alignment layer is laminated by using an applicator under a setting of a clearance of 100 μm. Thereafter, a film surface temperature was heated to 60° C. and dried for 1 minute to produce two sets of laminates having a spacer layer as a roll having a length of 50 m.

<Production of Fluid Cell (Liquid Crystal Cell)>

A liquid crystal layer composition was produced using the following formulation.

Liquid crystal layer composition

| | |
|---|---|
| ZLI2806 (manufactured by Merck Ltd.) | 100 parts by mass |
| Cholesteric Nonanoate (manufactured by Tokyo | 1.74 parts by mass |
| Chemical Industry Co., Ltd.) | |
| G-472 (manufactured by Hayashibara Co., Ltd.) | 3.00 parts by mass |

The two sets of rolls of the laminates having the spacer layer on the alignment layer, which were produced above, were continuously fed out. The liquid crystal layer composition produced above was applied to one of the rolls with a bar coater at a width of 90 cm. Thereafter, a liquid crystal cell precursor was produced by stacking laminates which have another spacer layer and which were not coated, and pinching the laminates in roll to roll with a nip roller.

While conveying the liquid crystal cell precursor, a heat source 200 at a temperature of 250° C. was brought into contact from the top and bottom for 5 seconds in a shape shown in FIG. 8 (length L=90 cm, width W=90 cm, width T=1 cm, and gap width B=3 cm). Therefore, the first sealing portion was formed by heat fusion welding of two plastic substrates. At this time, the first sealing portion was not formed on a portion corresponding to the gap of the heat source. In addition, several bubbles having a diameter of about 1 mm were generated in the gap portion of the heat source.

Next, as shown in FIG. 5, a plurality of first sealing portions were continuously formed so that a gap between the respective sealing portions became 5 cm.

Thereafter, as shown in FIG. 6, the liquid crystal cell precursor was cut at a central portion between two first sealing portions to produce a liquid crystal cell unit.

A linear heat source having a length of 6 cm, a width of 1 cm, and a temperature of 280° C. was brought into contact, for 5 seconds, with a portion in which the first sealing portion of the liquid crystal cell unit produced above was not formed. A second sealing portion was formed by heat fusion welding of two plastic substrates so as to be in contact with the first sealing portion, and therefore a liquid crystal cell 100 as shown in FIG. 7 was produced. In a case of forming the second sealing portion, a pressure was slightly applied to the upper and lower sides of a plastic cell, and several bubbles having a diameter of about 1 mm were extruded to the outside of the plastic cell to form the second sealing portion. A proportion of the first sealing portion to the entire sealing portion was 98.3%.

<Production of Three-Dimensional Fluid Cell (Three-Dimensional Liquid Crystal Cell)>

The produced liquid crystal cell was fixed to a mold prepared separately and heated at 155° C. for 30 minutes, followed by shrinkage molding, and therefore a three-dimensional liquid crystal cell was produced. A dimensional change at this time was −10%. The produced three-dimensional liquid crystal cell had a shape conforming to the mold, no whitening or cracking occurred, and an average light transmittance at 400 to 750 nm was maintained at 75%.

### Example 2

A liquid crystal cell and a three-dimensional liquid crystal cell were produced in the same manner as in Example 1 except that, in place of the polymer layer A, a polymer layer B was formed by the following method by using a polymer layer-coating solution prepared by the following formulation.

Formulation of polymer layer-coating solution

| | |
|---|---|
| PVA resin (Klare Poval PVA-105) | 100 parts by mass |
| Surfactant A | 0.5 parts by mass |
| Ethanol | 100 parts by mass |
| Distilled water | 100 parts by mass |

The produced polymer layer-coating solution was coated on a plastic substrate as in Example 1 using Bar Coater #20 at an application amount by which a film thickness becomes 10 μm, heated so that a film surface temperature became 80° C., and then dried for 30 minutes. Therefore, the polymer layer B was formed.

A permeability coefficient of oxygen and a moisture content of the polymer layer B were measured in the same manner as in Example 1. The results are shown in Table 1.

### Example 3

A liquid crystal cell and a three-dimensional liquid crystal cell were produced in the same manner as in Example 1 except that, in place of the polymer layer A, a polymer layer C was formed by the following method by using a polymer layer-coating solution prepared by the following formulation.

Formulation of polymer layer-coating solution

| | |
|---|---|
| Ethylene-vinyl alcohol copolymer (EVOH) [Soarnol | 100 parts by mass |
| D2908, manufactured by Nippon Gohsei Co., Ltd.] | |
| Surfactant A | 0.5 parts by mass |
| Ethanol | 100 parts by mass |
| Distilled water | 100 parts by mass |

The produced polymer layer-coating solution was coated on a plastic substrate as in Example 1 using Bar Coater #20 at an application amount by which a film thickness becomes heated so that a film surface temperature became 80° C., and then dried for 30 minutes. Therefore, the polymer layer C was formed.

A permeability coefficient of oxygen and a moisture content of the polymer layer C were measured in the same manner as in Example 1. The results are shown in Table 1.

### Example 4

A liquid crystal cell and a three-dimensional liquid crystal cell were produced in the same manner as in Example 1 except that, in place of the polymer layer A, a polymer layer D was formed by the following method by using a polymer layer-coating solution prepared by the following formulation.

Formulation of polymer layer-coating solution

| | |
|---|---|
| G-polymer (Nichigo G-polymer manufactured by | 100 parts by mass |
| Nippon Synthetic Chemical Co., Ltd.) | |
| Surfactant A | 0.5 parts by mass |
| Distilled water | 200 parts by mass |

The produced polymer layer-coating solution was coated on a plastic substrate as in Example 1 using Bar Coater #20 at an application amount by which a film thickness becomes 10 μm, heated so that a film surface temperature became 90° C., and then dried for 30 minutes. Therefore, the polymer layer D was formed.

A permeability coefficient of oxygen and a moisture content of the polymer layer D were measured in the same manner as in Example 1. The results are shown in Table 1.

### Example 5

A liquid crystal cell and a three-dimensional liquid crystal cell were produced in the same manner as in Example 1 except that, in place of the polymer layer A, a polymer layer E was formed by the following method by using a polymer layer-coating solution prepared by the following formulation.

Formulation of polymer layer-coating solution

| | |
|---|---|
| Epoxy resin [MAXIVE manufactured by Mitsubishi | 50 parts by mass |
| GasChemical: main agent (M-100)] | |
| Amine compound [MAXIVE manufactured by | 50 parts by mass |
| Mitsubishi Gas Chemical Co., Ltd.: hardener | |
| (C-93)] | |
| Surfactant A | 0.5 parts by mass |
| Ethanol | 200 parts by mass |

The produced polymer layer-coating solution was coated on a plastic substrate as in Example 1 using Bar Coater #20 at an application amount by which a film thickness becomes 10 μm, heated so that a film surface temperature became 80° C., and then dried for 30 minutes. Therefore, the polymer layer E was formed.

A permeability coefficient of oxygen and a moisture content of the polymer layer E were measured in the same manner as in Example 1. The results are shown in Table 1.

### Example 6

A liquid crystal cell and a three-dimensional liquid crystal cell were produced in the same manner as in Example 1 except that, in place of the polymer layer A, a polymer layer A1 was formed by coating a polymer layer-coating solution on a plastic substrate using Bar Coater #3 at an application amount by which a film thickness became 1 μm, heating so that a film surface temperature became 50° C., and then drying for 1 minute.

A permeability coefficient of oxygen and a moisture content of the polymer layer A1 were measured in the same manner as in Example 1. The results are shown in Table 1.

### Example 7

A liquid crystal cell and a three-dimensional liquid crystal cell were produced in the same manner as in Example 1 except that, in place of the polymer layer A, a polymer layer A2 was formed by adjusting a concentration of solid contents of the polymer layer-coating solution and coating the polymer layer-coating solution on the plastic substrate using Bar Coater #30 at an application amount by which a film thickness became 50 μm, heating so that a film surface temperature became 50° C., and then drying for 30 minutes.

A permeability coefficient of oxygen and a moisture content of the polymer layer A2 were measured in the same manner as in Example 1. The results are shown in Table 1.

### Example 8

A liquid crystal cell and a three-dimensional liquid crystal cell were produced in the same manner as in Example 1 except that, in place of the polymer layer A, a polymer layer A3 was formed by adjusting a concentration of solid contents of the polymer layer-coating solution and coating the polymer layer-coating solution on the plastic substrate using Bar Coater #60 at an application amount by which a film thickness became 100 μm, heating so that a film surface temperature became 50° C., and then drying for 30 minutes.

A permeability coefficient of oxygen and a moisture content of the polymer layer A3 were measured in the same manner as in Example 1. The results are shown in Table 1.

### Example 9

A liquid crystal cell and a three-dimensional liquid crystal cell were produced in the same manner as in Example 1 except that, in place of the polymer layer A, a polymer layer A4 was formed by adjusting a concentration of solid contents of the polymer layer-coating solution and coating the polymer layer-coating solution on the plastic substrate using Bar Coater #70 at an application amount by which a film thickness became 120 μm, heating so that a film surface temperature became 50° C., and then drying for 30 minutes.

A permeability coefficient of oxygen and a moisture content of the polymer layer A4 were measured in the same manner as in Example 1. The results are shown in Table 1.

### Comparative Example 1

A liquid crystal cell and a three-dimensional liquid crystal cell were produced in the same manner as in Example 1 except that the polymer layer A was not formed.

### Comparative Example 2

A liquid crystal cell and a three-dimensional liquid crystal cell were produced in the same manner as in Example 1 except that, in place of the polymer layer A, a polymer layer F was formed by the following method by using a polymer layer-coating solution prepared by the following formulation.

Formulation of polymer layer-coating solution

| | |
|---|---|
| Polycarbonate (PC) | 50 parts by mass |
| Dichloromethane | 200 parts by mass |

The produced polymer layer-coating solution was coated on a plastic substrate as in Example 1 using Bar Coater #10 at an application amount by which a film thickness becomes 10 μm, heated so that a film surface temperature became 50° C., and then dried for 30 minutes. Therefore, the polymer layer F was formed.

A permeability coefficient of oxygen and a moisture content of the polymer layer F were measured in the same manner as in Example 1. The results are shown in Table 1.

[Blending of Gas]

The produced three-dimensional liquid crystal cell was conditioned at 25° C. and a relative humidity of 50% for 24 hours and then heated at 140° C. for 30 minutes to check whether air bubbles were generated in the liquid crystal layer. Evaluation was performed based on the following standard. The results are shown in Table 1.

AA: No bubbles were observed in the liquid crystal layer.

A: One bubble having a diameter of about 1 mm was observed in the liquid crystal layer.

B: Two or more and less than ten bubbles having a diameter of about 1 mm were observed in the liquid crystal layer.

C: Ten or more bubbles having a diameter of about 1 mm were observed in the liquid crystal layer.

TABLE 1

| | Polymer layer | | | | |
|---|---|---|---|---|---|
| | | Film | Permeability coefficient of | Moisture | |
| | | thickness | oxygen | content | Blending of |
| | Types | (μm) | (cc · mm/m² · day · atm) | (% by mass) | gas |
| Example 1 | BLEMMER | 10 | 0.4 | 0.90 | AA |
| | GLM* | | | | |
| Example 2 | PVA | 10 | 10 | 0.52 | A |
| Example 3 | EVOH | 10 | 0.4 | 0.75 | AA |
| Example 4 | G-polymer | 10 | 0.6 | 0.69 | AA |
| Example 5 | MAXIVE | 10 | 0.7 | 0.49 | AA |
| Example 6 | BLEMMER | 1 | 0.4 | 0.09 | AA |
| | GLM* | | | | |
| Example 7 | BLEMMER | 50 | 0.4 | 4.50 | A |
| | GLM* | | | | |
| Example 8 | BLEMMER | 100 | 0.4 | 9.00 | A |
| | GLM* | | | | |
| Example 9 | BLEMMER | 120 | 0.4 | 11.00 | A |
| | GLM* | | | | |
| Comparative | None | — | — | — | C |
| Example 1 | | | | | |
| Comparative | PC | 10 | 60 | 10.00 | B |
| Example 2 | | | | | |

*Polymethacrylic acid ester having a hydroxyl group polymerized with BLEMMER GLM

Based on the results shown in Table 1, it was found that, in a case where the polymer layer was not present, a gas was blended into the fluid layer (Comparative Example 1).

In addition, it was found that, in a case where a permeability coefficient of oxygen was greater than 50 cc·mm/m²·day·atm, an effect of curbing blending of a gas into the fluid layer was insufficient (Comparative Example 2).

On the other hand, it was found that, in a case where the polymer layer having a permeability coefficient of oxygen in 50 cc·mm/m²·day·atm or less was provided, it was possible to curb blending of gas into the fluid layer (Examples 1 to 9).

In addition, from the comparison of Examples 1 to 5, it was found that, in a case where a permeability coefficient of oxygen in the polymer layer was 0.1 to 5 cc·mmi/m²·day·atm, it was possible to more favorably curb blending of gas into the fluid layer.

In addition, from the comparison of Examples 1 and 6 to 9, it was found that, in a case where a moisture content of the polymer layer was 0.05% to 4% by mass, it was possible to more favorably curb blending of gas into the fluid layer.

### Comparative Example 3

A liquid crystal cell and a three-dimensional liquid crystal cell were produced in the same manner as in Example 1 except that, in place of the polymer layer A, a SiO₂ film was sputtered and formed on a plastic substrate.

As a result, it was found that the SiO₂ film could not follow the deformation of the plastic film, and thus a crack was generated, and therefore it was not possible to curb blending of gas into the fluid layer.

### EXPLANATION OF REFERENCES

1: first plastic substrate
2: polymer layer
3: fluid layer
4: second plastic substrate
5: first conductive layer
6, 7: alignment layer
8: polymer layer
9: second conductive layer
10: first sealing portion
20: second sealing portion
30: through-hole
100: fluid cell
101: fluid cell precursor
102: fluid cell unit
200: heat source

What is claimed is:

1. A fluid cell comprising:
a first plastic substrate;
a first conductive layer;
a fluid layer;
a second conductive layer;
a second plastic substrate in this order;
a polymer layer between the first plastic substrate and the fluid layer; and
a polymer layer between the second plastic substrate and the fluid layer,
wherein at least one of the first plastic substrate or the second plastic substrate is a heat-shrinkable film that satisfies a heat shrinkage rate of 5% to 75%, and
a permeability coefficient of oxygen in the polymer layer is 50 cc·mm/m²·day·atm or less.

2. The fluid cell according to claim 1, wherein a moisture content of the polymer layer is less than 10% by mass.

3. The fluid cell according to claim 1, wherein a thickness of the polymer layer is 100 μm or less.

4. The fluid cell according to claim 2, wherein a thickness of the polymer layer is 100 μm or less.

5. The fluid cell according to claim 1, further comprising:
an alignment layer between the first conductive layer and the fluid layer; and
an alignment layer between the second conductive layer and the fluid layer,
wherein the fluid layer is a liquid crystal layer formed by using a liquid crystal composition that contains a liquid crystal compound.

6. The fluid cell according to claim 2, further comprising:
an alignment layer between the first conductive layer and the fluid layer; and
an alignment layer between the second conductive layer and the fluid layer,
wherein the fluid layer is a liquid crystal layer formed by using a liquid crystal composition that contains a liquid crystal compound.

7. The fluid cell according to claim 3, further comprising:
an alignment layer between the first conductive layer and the fluid layer; and
an alignment layer between the second conductive layer and the fluid layer,
wherein the fluid layer is a liquid crystal layer formed by using a liquid crystal composition that contains a liquid crystal compound.

8. A three-dimensional fluid cell which is formed by dimensionally changing the fluid cell according to claim 1 at a rate of 5% to 75%.

9. A three-dimensional fluid cell which is formed by dimensionally changing the fluid cell according to claim 2 at a rate of 5% to 75%.

10. A three-dimensional fluid cell which is formed by dimensionally changing the fluid cell according to claim 3 at a rate of 5% to 75%.

11. A three-dimensional fluid cell which is formed by dimensionally changing the fluid cell according to claim 4 at a rate of 5% to 75%.

12. A three-dimensional fluid cell which is formed by dimensionally changing the fluid cell according to claim 5 at a rate of 5% to 75%.

13. A three-dimensional fluid cell which is formed by dimensionally changing the fluid cell according to claim 6 at a rate of 5% to 75%.

14. A three-dimensional fluid cell which is formed by dimensionally changing the fluid cell according to claim 7 at a rate of 5% to 75%.

15. A three-dimensional fluid cell comprising:
a first plastic substrate;
a first conductive layer;
a fluid layer;
a second conductive layer;
a second plastic substrate in this order;
a polymer layer between the first plastic substrate and the fluid layer; and
a polymer layer between the second plastic substrate and the fluid layer,
wherein a permeability coefficient of oxygen in the polymer layer is 50 cc·mm/m²·day·atm or less.

16. A method for manufacturing a three-dimensional fluid cell which is produced by using a laminate including a first plastic substrate, a first conductive layer, a fluid layer, a second conductive layer, and a second plastic substrate in this order, and further including a polymer layer between the first plastic substrate and the fluid layer, and a polymer layer between the second plastic substrate and the fluid layer, in which at least one of the first plastic substrate or the second plastic substrate is a heat-shrinkable film that satisfies a heat shrinkage rate of 5% to 75%, and a permeability coefficient of oxygen in the polymer layer is 50 cc·mm/m²·day·atm or less, the method comprising, in this order:
a laminate production step of producing the laminate;
a two-dimensional fluid cell production step of sealing the fluid layer to produce a two-dimensional fluid cell; and
a three-dimensional processing step of heating and three-dimensionally processing the two-dimensional fluid cell to produce the three-dimensional fluid cell.

17. The method for manufacturing a three-dimensional fluid cell according to claim 16, wherein the heat-shrinkable film is an unstretched thermoplastic resin film.

18. The method for manufacturing a three-dimensional fluid cell according to claim 16, wherein the heat-shrinkable film is a thermoplastic resin film stretched within a range of greater than 0% and 300% or lower.

19. The method for manufacturing a three-dimensional fluid cell according to claim 16, wherein both of the first plastic substrate and the second plastic substrate are the heat-shrinkable film that satisfies the heat shrinkage rate of 5% to 75%.

20. The method for manufacturing a three-dimensional fluid cell according to claim 16, wherein the three-dimensional processing step is a three-dimensional processing step involving shrinkage of the heat-shrinkable film due to heating.
